(19) United States
(12) Patent Application Publication
(10) Pub. No.: US 2026/0228618 A1
(43) Pub. Date: Aug. 6, 2026

(54) ASSISTING AN ANALYTICS TRAINING FUNCTION TO SELECT A MACHINE LEARNING MODEL IN A WIRELESS COMMUNICATION NETWORK

(71) Applicant: Lenovo (Singapore) Pte. Ltd., Singapore (SG)

(72) Inventors: Konstantinos SAMDANIS, Munich (DE); Emmanouil PATEROMICHELAKIS, Viersen (DE); Dimitrios KARAMPATSIS, Ruislip (DE)

(21) Appl. No.: 19/153,123

(22) PCT Filed: Mar. 20, 2023
(86) PCT No.: PCT/EP2023/057091

§ 371 Date: Aug. 1, 2025

(30) Foreign Application Priority Data
Feb. 3, 2023 (GR) 20230100088

(51) Int. Cl. G06N 20/00

(52) U.S. Cl. CPC G06N 20/00

(57) ABSTRACT

There is provided a method in an apparatus for wireless communication. The method comprising determining, if training is required for a first machine learning, ML, model; and then determining, whether to: train the first ML model using data from at least one online data source, or to select and retrieve from a first repository function, a second ML model, and to use the second ML model to replace the first ML model for performing the training.

### FIELD

The subject matter disclosed herein relates generally to the field of implementing the assisting of an analytics training function to select a machine learning model in a wireless communication network. This document defines an apparatus and method for wireless communication.

### INTRODUCTION

Network analytics and artificial intelligence (AI)/machine learning (ML) is deployed in the fifth generation (5G) core network by introducing of a network data analytics function (NWDAF) that considers the support of various analytics types as elaborated in the 3^{rd} generation partnership project (3GPP) specification TS 23.288. Each NWDAF may support one or more Analytics identifiers (IDs) and may have the role of inference called the NWDAF analytics logical function (AnLF), or training called the NWDAF model training logical function (MTLF) or both. An AnLF that supports a specific Analytics ID inference subscribes to a corresponding MTLF that is responsible for training. There are various NWDAF flavors, in addition to respective input data and output result consumers.

3GPP TS 23.288 introduces the analytics data repository function (ADRF) that supports storage and retrieval of analytics generated by NWDAFs and other collected data. Further, in 3GPP TR 23.700-81, the ADRF storage and retrieval services are enhanced supporting ML models. In other words, it is proposed that the ADRF supports trained ML model(s) file and/or ML model file serialization and/or ML model topology and weight(s) format or any other relevant format that can represent an ML model stored by a network function (NF) consumer i.e., NWDAF containing MTLF; and trained ML model(s) retrieval by a NF consumer i.e., NWDAF containing MTLF or NWDAF containing AnLF.

An ML model in machine learning is created by an ML algorithm. In other words, an ML algorithm specifies a procedure, e.g., pattern recognition, that runs considering data (i.e., training data) to create an ML model. These processes in machine learning can be commonly defined as specified in the following paragraphs.

An ML model can be a mathematical representation of a real-world process. To generate an ML model, one needs to provide training data to an ML algorithm to learn from. An ML model can then be used for ML inference or simply inference.

ML inference is a process where an ML model is fed with observation data, (i.e., data from where the ML model operates), and calculates an output result. This process is commonly referred to as “operationalizing a machine learning model” or “putting a machine learning model into production”.

An ML algorithm is the hypothesis set that is taken at the beginning before the training starts with real-world data. For instance, a hypothesis set considering a Linear Regression algorithm means a set of functions that share the characteristics defined by Linear Regression. From those set of functions, an ML model is the selected function that fits best the training data.

ML training is a process where an ML algorithm is fed with training data to find patterns such that the input parameters correspond to the target. The output of the training process is an ML model, which can be used to provide analytics results. This process is also referred to as “learning”.

U.S. Pat. No. 10,572,321B2 “Machine learning repository service”, describes a method for providing and retrieving listed repository items such as algorithms, data, models, pipelines, and/or notebooks. A consumer places a query using an application programming interface (API) to find and select shared content to build a ML pipeline and/or cause the execution or training of a selected ML model.

Further, the notion of an ML Model profile is introduced in 3GPP TR 23.700-81, which adopts the ML Model info provided in the 3GPP TS 23.288 including one or more of the following parameters: identification of the location related to the ML model, e.g., NWDAF ID, ADRF ID; ML Model ID related to each historical ML model version stored (without being defined); analytics ID and model framework (i.e., analytics type); ML model implementation details, (e.g., model platform, model type, compilation language, etc.); ML model interoperability, (i.e., if the model retrieved can be used in the indicated platform or vendor); ML model deployment information including spatial validity, model validity period, accuracy, slice, target objects (e.g., UE(s), NF(s)) and other model content information as specified in clause 6.2A.2 TS 23.288; and notification end point that is expected to receive the ML model.

### SUMMARY

A problem currently exists with ML model storage and retrieval as there is no mechanism to check when and under which conditions a stored ML Model in a NF or repository or ADRF shall be adopted to exploit the benefits of re-using a ML Model across different MTLFs with a different area of interest. To accomplish this, the invention disclosed herein provides apparatuses and methods that provide such a mechanism, that may take advantage of the unique ML Model ID that is associated with a ML Model profile and/or ML Model Information to be able to select stored ML Models. This invention fills the gap of the discovery mechanisms for selecting the appropriate or optimal ML Model stored in ADRF or in model repository, for the purpose of ML model training/re-training.

In addition, this invention introduces a mechanism to assist the ML Model update proactively across multiple MTLFs, by keeping track of the MTLFs that employ the same ML model and may be beneficial to get a new version once this becomes available. A new ML Model version may include an ML Model evolution, i.e., a new ML Model based on a previous one, or ML Model profile or ML Model info update that captures the network environment that a ML Model was trained and performed sufficiently.

Disclosed herein are procedures for assisting an analytics training function to select a machine learning model in a wireless communication network. Said procedures may be implemented by an apparatus and method for wireless communication.

There is provided, an apparatus for wireless communication, comprising a processor and a memory coupled with the processor. The processor is configured to cause the apparatus to determine, if training is required for a first machine learning, ML, model; and then determine, whether to: train the first ML model using data from at least one online or offline (historical) data source, or, select and retrieve from a first repository function, a second ML model, and to use the second ML model to replace the first ML model for performing the training.

There is further provided, a method in an apparatus for wireless communication, comprising determining, if training is required for a first machine learning, ML, model; and then determining, whether to: train the first ML model using data from at least one online data source; or select and retrieve from a first repository function, a second ML model, and to use the second ML model to replace the first ML model for performing the training.

There is further provided, an apparatus for wireless communication, comprising a processor and a memory coupled with the processor. The processor is configured to cause the apparatus to: receive, from an analytics training function, an ML model update, the ML model update comprising an updated ML model and an associated ML model identifier and/or ML model profile and/or an ML model profile category and/or an ML model information; determine, based on the ML model update, at least one other analytics training function that is subscribed to the apparatus to receive ML model updates for the ML model identifier and/or ML model profile and/or ML model profile category and/or ML model information; and transmit, to the at least one other analytics training function, the ML model update.

There is further provided, a method in an apparatus for wireless communication, comprising: receiving, from an analytics training function, an ML model update, the ML model update comprising an updated ML model, an associated ML model identifier and/or a ML model profile and/or a ML model category and/or a ML model information; determining, based on the ML model update, at least one other analytics training function subscribed to the apparatus to receive ML model updates for the ML model identifier and/or ML model profile and/or ML model category and/or ML model information; and transmitting, to the at least one other analytics training function, the ML model update.

As used herein, the term ‘training’ includes both training and re-training, for instance, or ML models.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for assisting of an analytics training function to select a machine learning model in a wireless communication network will now be described, by way of example only, with reference to the accompanying drawings, in which:

FIG. 1 illustrates an embodiment of a wireless communication system;

FIG. 2 illustrates an embodiment of a user equipment apparatus;

FIG. 3 illustrates an embodiment of a network node;

FIG. 4 illustrates an embodiment of various NWDAF flavours and respective input data and output result consumers;

FIG. 5 illustrates an embodiment of a data storage architecture for analytics and collected data;

FIG. 6 illustrates an embodiment of a method of a method in an apparatus for wireless communication;

FIG. 7 illustrates an embodiment of an ML model update at AnLF with an MTLF training performed using a stored ML model;

FIG. 8 illustrates an embodiment of an alternative method of in an apparatus for wireless communication; and

FIG. 9 illustrates an embodiment of an ML model update via DCCF/MFAF towards corresponding MTLFs.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

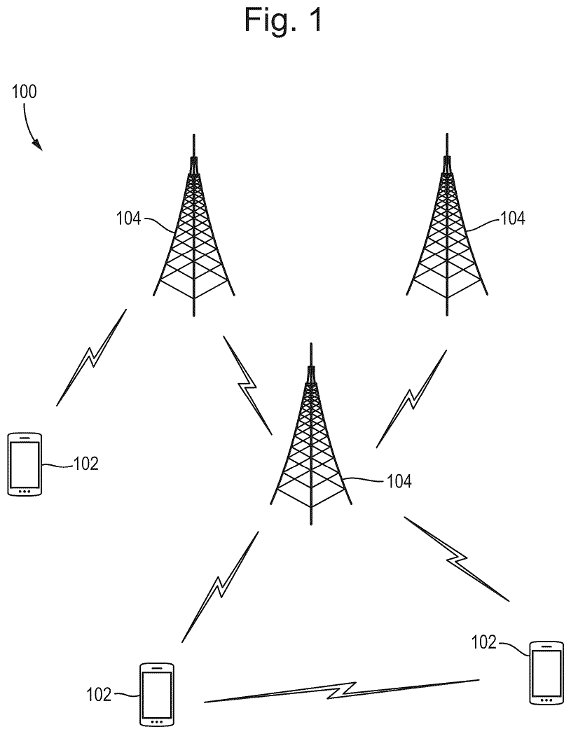

FIG. 1 depicts an embodiment of a wireless communication system 100 for assisting of an analytics training function to select a machine learning model in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

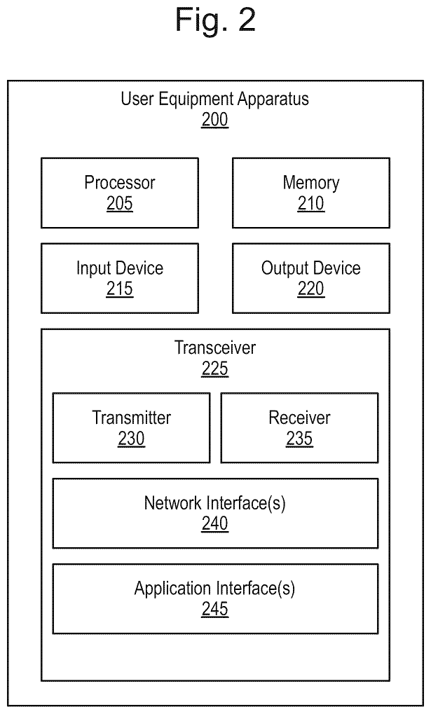

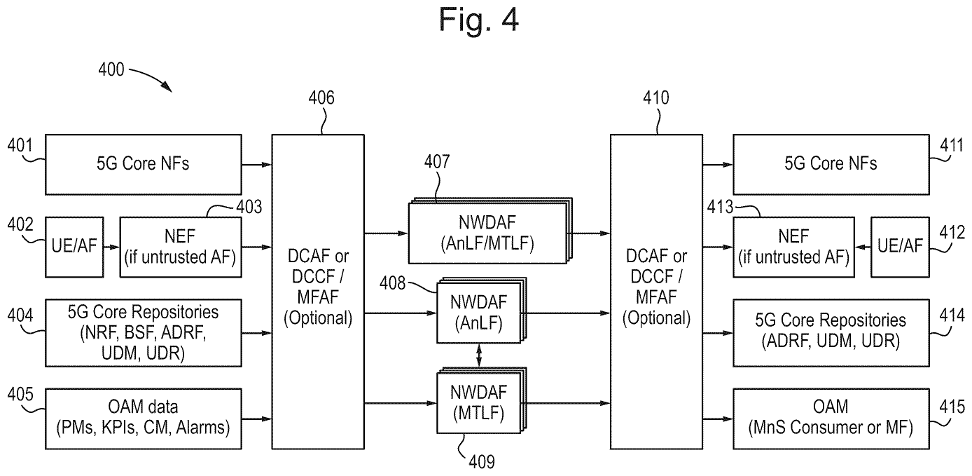

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise 102 from FIG. 1, 402 or 412 from FIG. 4, for instance. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

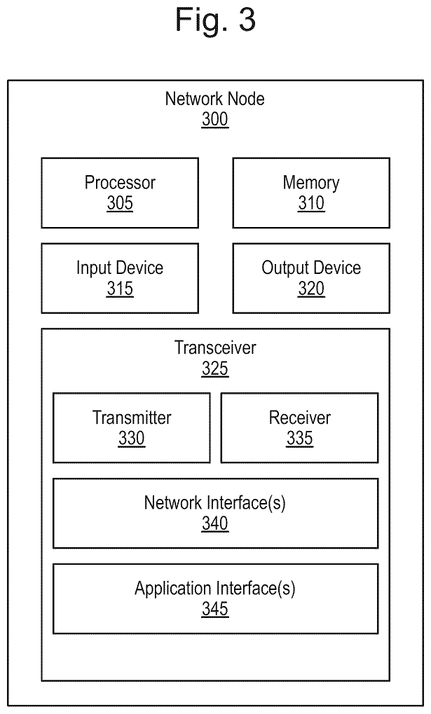

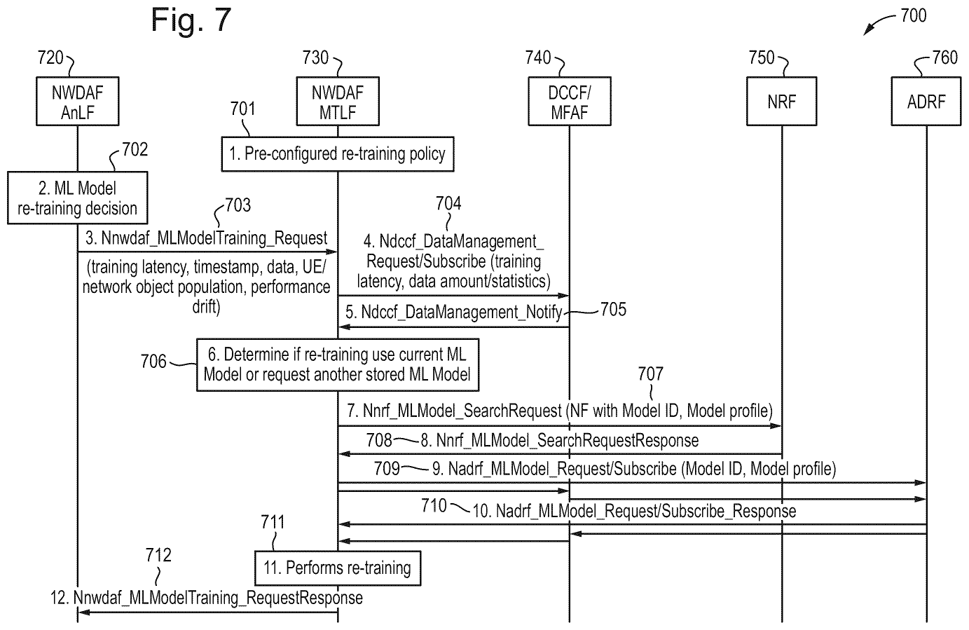

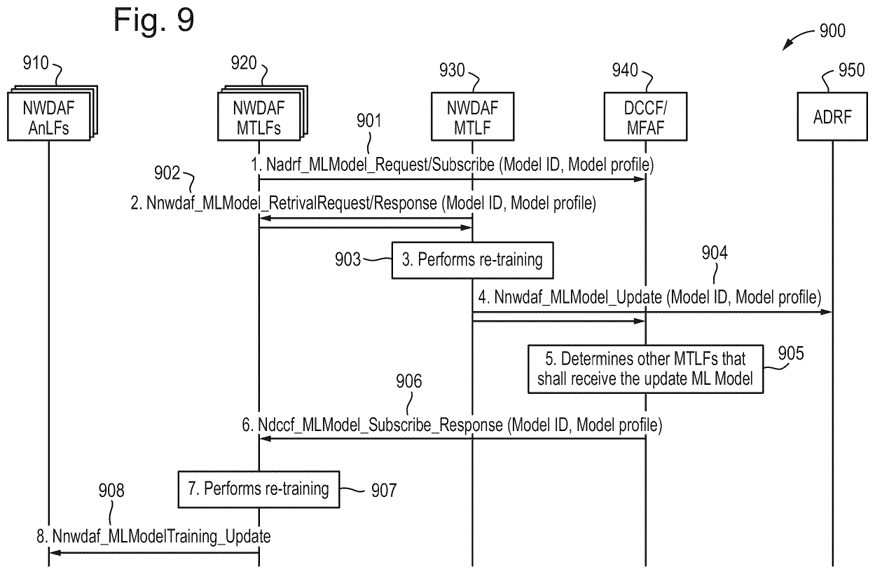

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise 720, 730, 740, 750 or 760, from FIG. 7, for instance, or may comprise 910, 920, 930, 940, or 950, from FIG. 9, for instance. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

FIG. 4 illustrates an overview 400 of various NWDAF flavours and respective input data and output result consumers. Input sources are shown as comprising 5G core NFs 401, UE/AF 402 (plus NEF 403 if AF 402 is untrusted), 5G core repositories 404 (NRF, BSF, ADRF, UDM, UDR) and OAM data 405 (PMs, KPIs, CM, Alarms). These input sources are illustrated as providing input to a DCAF or DCCF/MF AF 406 (optional). The DCAF or DCCF/MFAF 406 is illustrated as inputting to an NWDAF (AnLF/MTLF) 407, an NWDAF (AnLF) 408 and an NWDAF (MTLF) 409. The NWDAF (AnLF) 408 and NWDAF (MTLF) 409 are shown inputting and outputting to each other. The NWDAFs 407-409 are illustrated as providing outputs to a further DCAF or DCCF/MFAF 410 (optional) on an output consumer side of the figure. The DCAF or DCCF/MFAF 410 outputs to any of 5G core NFs 411, UE/AF 412 (via NEF 413 if AF 412 is untrusted), 5G core repositories 414 (ADRF, UDM, UDR) and OAM 415 (MnS consumer or MF).

More specifically, FIG. 4 illustrates the various NWDAF flavors and their respective input data and output result consumers, which may include 5G core NFs 401 and 411, AFs 402 and 412, 5G core repositories 404 and 414, e.g., NRF, UDM, etc., and the OAM (MnS Consumer or MF). MTLF 409 and AnLF 408 may exchange AI/ML models, e.g., via the means of serialization or containerization. Optionally, DCCF and MFAF may be involved to distribute and collect repeated data towards or from various data sources.

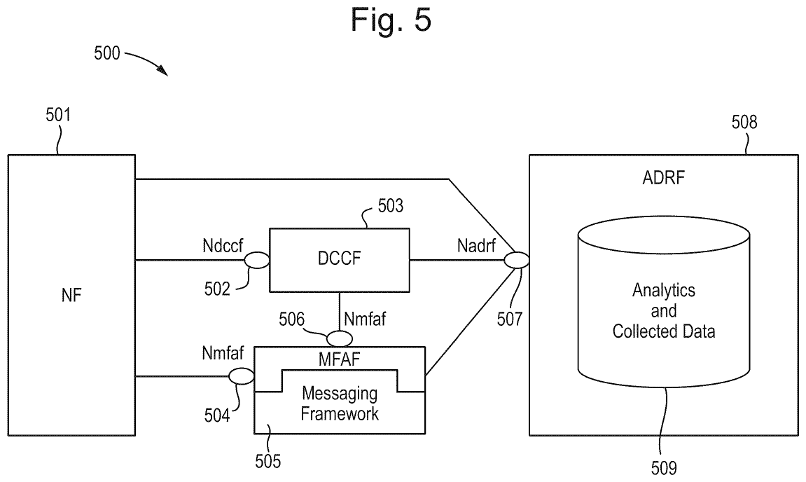

FIG. 5 illustrates an embodiment 500 of a data storage architecture for analytics and collected data. The figure illustrates an NF 501 connected to a DCCF 503 via Ndccf 502. The NF 501 also connects to MFAF messaging framework 505 via Nmfaf 504. The DCCF 503 and MFAF messaging framework 505 are shown connected via Nmfaf 506. All of NF 501, DCCF 503 and MFAF messaging framework 505 connect to an ADRF 508 via Nadrf 507. The ADRF 508 is shown comprising analytics and collected data 509.

More specifically, the options supported in 5G by architecture 500 include ADRF 508 provides storage and retrieval of data by other 5GC NFs 501 (e.g., NWDAF).

Based on the NF request or configuration on the DCCF 503, the DCCF 503 may determine the ADRF 508 and interact directly or indirectly with the ADRF 508 to request or store data. The interaction can be direct: the DCCF 503 requests to store data in the ADRF 508, or via a notification (e.g., when ADRF 508 requested data collection notification via DCCF 503). In addition, the DCCF 503 retrieves data from the ADRF 508. The interaction can also be indirect: the DCCF 503 requests the Messaging Framework 505 to store data in the ADRF 508. The Messaging Framework 505 may contain one or more adaptors that translate between 3GPP defined protocols.

A Consumer NF 501 may specify in requests to a DCCF 503 that data provided by a data source needs to be stored in the ADRF 508.

The ADRF 508 stores data received directly from an NF 501, or data received in a notify message from the DCCF 503, MFAF 505 or from the NWDAF.

The ADRF 508 checks if the data consumer is authorized to access ADRF services and provides the requested data using the procedures specified in TS 23.501 clause 7.1.4.

The invention disclosed herein relates to an apparatus and method that may use a unique ML Model ID that is associated with a ML model profile that describes the training and inference conditions. ML Models stored in ADRF or in a model repository can be used to provide training and re-training, and can be shared among MTLFs, which may involve ensuring that the vendor information allows this to take place.

More than one ML model may be available to choose for a specific Analytics ID. The ML Model selection may be based on the semantics of the ML Model profile and may contain one or more of the following attributes: Analytics ID and Event ID information; AI/ML Algorithm(s) information used to produce or train the ML Model; network configuration or network context information obtained from an operations, administration and maintenance (OAM) function; time stamp when the ML Model training took place; data information used for ML model training; ML Model characteristics information obtained by the NWDAF; hardware characteristics for ML Model training and inference; interoperability in terms of hardware, software, platform, and vendor information (e.g., vendor ID, MTLF ID); and version that reflects the history or evolution of the ML model.

A ML Model ID and a respective profile can help the NWDAF MTLF to choose the most relevant ML model for interference or training considering the algorithm used for training, the conditions of training, and the inference requirements. Typically, the ML model profile is created by the MTLF, but another NF could be used, i.e., an NF that can take a role of a coordinator and be responsible for the creation and maintenance of the ML Model profile. To be able to discover a ML Model profile, the process shall be able to search into either an NF's contents or consider a pre-arranged, i.e., a pre-configured, categorization of NFs based on ML Model profiles. Once a ML Model is stored in ADRF or in another repository, it can be re-used when needed. In principle, a ML Model can be adopted in both AnLF and MTLF, but the need for model validation before use, i.e., before inference, makes the MTLF a safer solution.

The disclosure herein proposes to select a ML Model that is stored to start the training process or replace the ML Model that is evolved in the MTLF with another ML Model stored in ADRF once certain conditions arise that impact ML Model training. Typically, a stored ML Model can assist a respective MTLF in a number of ways, as outlined in the following paragraphs.

A stored ML model can assist a respective MTLF by building on the top of gained experience and avoiding the training of a ML Model from scratch or from an earlier state; a process that requires significantly less data.

Using a stored ML model can result in a speeding up of the process of re-training since there is a need to collect significantly less data or even no need to collect data at all, to perform ML Model re-training.

A stored ML model can save resources and energy either with respect to the MTLF and/or data sources, since handling less data requires less storage, random access memory (RAM), and computer processing unit (CPU) resource, and consequently it requires less energy expenditure.

A stored ML model can further assist a respective MTLF by hardening analytics resilience in case of ML Model fault inside the MTLF or in case of faulty or unavailable data sources (i.e., in case of lack of input data for the purpose of training).

The selection of a stored ML model may be initiated by the respective MTLF. The selection of a stored ML Model can be determined using the ML Model ID and/or ML model profile and/or by the parameters inside the ML Model information. Such an MTLF may collect data from the related data sources, which can be identified considering the Analytics ID and the area of interest, to have some fresh data from the network at least for the verification and testing process. If fresh data is not available, then the respective MTLF can request historic data with similar characteristics from the ADRF. Data with similar characteristics can be indicated based on one or more of the following criteria: i) type of source, ii) area of interest, iii) data statistics, and iv) time stamp.

If the MTLF needs to initiate an ML model for the first time it can rely on the pre-configured ML model ID and associated ML model profile. Then the MTLF needs to check if the ML model equipped is the latest one or another version exists in the repository, e.g., ADRF. For this purpose, it can check using the ML Model ID the latest version and carry out an update, i.e., get the latest ML Model from the repository, e.g., ADRF, if needed.

In case the MTLF is already running an ML model it can decide whether the current ML Model shall be re-trained using new collected data or request to replace it with a stored ML Model before performing re-training. The option that is more beneficial for this case can be considered based on one or more conditions.

Consideration may be given to whether an availability and/or quantity of data from existing sources is sufficient or not to meet the desired learning curve of the ML Model. Availability may rely on real-time data demands and/or on the population or percentage of UEs and/or network objects, while the quantity can be determined based on data statistics semantics (e.g., data volume, range, distribution). If the data is characterized as sufficient then the MTLF may use it to provide re-training, otherwise it may request to start the re-training from an existing ML Model.

Consideration may be given to inference information related to ML Model performance drift determined at AnLF. If the ML Model performance drift is beyond a pre-configured limit, then the MTLF may request to re-start the re-training using a stored ML Model. This may save time, resources and speed up the learning curve if a stored ML Model has “experience” (i.e., is trained already) under these new network conditions.

Consideration may be given to post training information related to expected ML model performance and/or model validation/testing which can assist the MTLF to evaluate the use of existing data sources. If the re-trained ML Model performance is below pre-configured limits, then the MTLF may request to re-start the re-training from an existing ML Model. An MTLF may additionally or alternatively compare the ML model performance and/or model validation/testing of various stored ML Models (ideally off-line) to choose the optimal one for (re-)training.

The required speed of re-training may be considered, which may be impacted by the time needed to collect new data and by computing availability characteristics, (e.g., CPU, RAM, storage), which at an MTLF may influence the decision to perform ML Model re-training based on new data or to request to start the re-training from an existing ML Model.

Consideration may be given to resource or energy constraints at an MLTF that may impact how many, i.e., the amount, of re-training or training processes the MTLF can handle considering the computing availability characteristics, (e.g., CPU, RAM, storage), and the energy expenditure goal targets.

Consideration may be given to policy pre-configured at an MTLF which may recommend checking always if an existing ML Model stored in ADRF can assist in re-training. Such a process may rely on for example on a time schedule, i.e., check if a current or a ML Model stored in ADRF can assist re-training considering a particular time instance (e.g., pick times or off-pick times). Otherwise, in case that is not possible, the policy may dictate the use of new data collected from data sources in the geographical area is used for re-training.

A new ML Model version can be distributed proactively and effectively taking advantage of the data collection coordination functionality (DCCF)/messaging framework adaptor function (MFAF) among subscribed NWDAF MTLFs considering the ML Model ID and the model profile.

The proposed solution can enhance the ML model training process at an MTLF, which may select a ML Model stored in ADRF using, for instance, the ML Model ID and/or ML Model profile and/or ML Model information parameters.

The disclosure herein provides an apparatus for wireless communication, comprising: a processor; and a memory coupled with the processor, the processor configured to cause the apparatus to: determine, if training is required for a first machine learning, ML, model; and then determine, whether to: train the first ML model using data from at least one online data source; or select and retrieve from a first repository function, a second ML model, and to use the second ML model to replace the first ML model for performing the training.

In some embodiments the processor is configured to cause the apparatus to: receive, from a first network entity a request for training the first ML model; and determine if training is required based on the request for training.

In some embodiments the request for training, comprises one or more parameters from the list of parameters consisting of: a required latency, or a speed, of training; a required amount or percentage sample of user equipment and/or network entities for providing a required amount of training data; an inference information related to ML model performance drift; and a time-schedule or a time-stamp for the request.

In some embodiments the first network entity is a network data analytics function, NWDAF, analytics inference function, analytics logical function, AnLF.

In some embodiments the processor is configured, in determining to select and retrieve from the first repository function the second ML model, to cause the apparatus to: transmit, to the first repository function, a request for retrieving the second ML model, wherein the request for retrieving comprises, an ML model identifier, and/or an ML model profile, and/or an ML model profile category, and/or an ML Model information; and receive, from the first repository function, the second ML model, the second ML model being associated with the ML model identifier, and/or ML model profile, and/or ML model profile category, and/or ML Model Information.

In some embodiments the processor is further configured to cause the apparatus to transmit, to a second repository function, a search request, the search request comprising the ML model identifier, and/or the ML model profile, and/or the ML model profile category, and/or the ML model information; and receive from the second repository function, an identifier for the first repository function.

In some embodiments the second repository function is a network repository function, NRF.

In some embodiments the processor is configured to cause the apparatus to perform the training using the second ML model, thereby generating an updated second ML model as a third ML model. Optionally, permission may be requested of the original ML model creator, before updating or training a ML model.

In some embodiments the processor is configured, in determining to train the first ML model using data from the at least one online data source, to cause the apparatus to perform the training using the first ML model and the data from the at least one online data source, thereby generating an updated first ML model as a third ML model.

In some embodiments the processor is configured to cause the apparatus to transmit the third ML model to the first network entity that requested the training.

In some embodiments the processor is configured to cause the apparatus to transmit the third ML model to at least another network entity that is subscribed to receiving ML model updates. Optionally, for a re-trained ML model, if this results in a new model, it may be stored to an ADRF or other repository function.

In some embodiments the apparatus comprises an analytics training function, NWDAF model training logical function, MTLF.

In some embodiments the processor is further configured to cause the apparatus to determine if training is required based on: an availability and/or quantity of data from the at least one online data source or from stored data. This data may be stored in a first repository function or another repository.

In some embodiments the availability of data is determined by a requirement for real-time data and/or an amount or percentage sample of user equipment and/or network entities for providing a required amount of training data; and the quantity of data is determined based on data statistics semantics. Data statistics semantics may comprise data volume, range, distribution, for instance.

In some embodiments the processor is further configured to cause the apparatus to determine if training is required based on one or more further parameters selected from the list of further parameters consisting of: a post-training information related to performance of the first and/or second ML models, wherein the post-training information comprises validation and/or testing information; a data source type of the at least one online data source and/or statistics related to the data collected from the at least one online data source; a resource and/or energy expenditure target constraint; a latency constraint target for collecting data from the at least one online data source, for training the first ML model, or retrieving and using a second ML model for training; and a pre-configured policy. The policy may include time schedule, threshold limits on ML performance, latency, energy and/or resource usage.

In some embodiments, the first repository function is an analytical data repository function, ADRF, or an analytics training function, NWDAF MTLF, or a model coordination function or a model repository function.

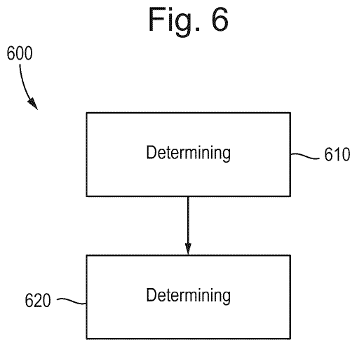

FIG. 6 illustrates an embodiment of a method 600 in an apparatus for wireless communication.

A first step 610 comprises determining, if training is required for a first machine learning, ML, model.

A second step 620 comprises determining, whether to: train the first ML model using data from at least one online data source; or select and retrieve from a first repository function, a second ML model, and to use the second ML model to replace the first ML model for performing the training.

In certain embodiments, the method 600 may be performed by a processor executing program code, for example, a microcontroller, a microprocessor, a CPU, a GPU, an auxiliary processing unit, a FPGA, or the like.

Some embodiments comprise receiving, from a first network entity a request for training the first ML model; and determining if training is required based on the request for training.

In some embodiments the request for training, comprises one or more parameters from the list of parameters consisting of: a required latency, or a speed, of training; a required amount or percentage sample of user equipment and/or network entities for providing a required amount of training data; an inference information related to ML model performance drift; and a time-schedule or a time-stamp for the request.

In some embodiments the first network entity is a network data analytics function, NWDAF, analytics inference function, analytics logical function, AnLF.

Some embodiments comprise, in determining to select and retrieve from the first repository function the second ML model, transmitting, to the first repository function, a request for retrieving the second ML model, wherein the request for retrieving comprises, an ML model identifier, and/or an ML model profile, and/or an ML model profile category, and/or an ML Model information; and receiving, from the first repository function, the second ML model, the second ML model being associated with the ML model identifier, and/or ML model profile, and/or ML model profile category, and/or ML Model Information.

Some embodiments comprise transmitting, to a second repository function, a search request, the search request comprising the ML model identifier, and/or the ML model profile, and/or the ML model profile category, and/or the ML model information; and receiving from the second repository function, an identifier for the first repository function.

In some embodiments the second repository function is a network repository function, NRF.

Some embodiments comprise performing the training using the second ML model, thereby generating an updated second ML model as a third ML model. Optionally, permission may be requested of the original ML model creator, before updating or training a ML model.

Some embodiments, in determining to train the first ML model using data from the at least one online data source, comprise performing the training using the first ML model and the data from the at least one online data source, thereby generating an updated first ML model as a third ML model.

Some embodiments comprise transmitting the third ML model to the first network entity that requested the training.

Some embodiments comprise transmitting the third ML model to at least another network entity that is subscribed to receiving ML model updates. Optionally, for a re-trained ML model, if this results in a new model, it may be stored to an ADRF or other repository function.

In some embodiments the apparatus comprises an analytics training function, NWDAF model training logical function, MTLF.

Some embodiments comprise determining if training is required based on an availability and/or quantity of data from the at least one online data source or from stored data. This data may be stored in the first repository function or another repository.

Some embodiments comprise determining the availability of data based on a requirement for real-time data and/or an amount or percentage sample of user equipment and/or network entities for providing a required amount of training data; and determining the quantity of data based on data statistics semantics. Data statistics semantics may comprise data volume, range, distribution, for instance.

Some embodiments comprise determining if training is required based on one or more further parameters selected from the list of further parameters consisting of: a post-training information related to performance of the first and/or second ML models, wherein the post-training information comprises validation and/or testing information; a data source type of the at least one online data source and/or statistics related to the data collected from the at least one online data source; a resource and/or energy expenditure target constraint; a latency constraint target for collecting data from the at least one online data source, for training the first ML model, or retrieving and using a second ML model for training; and a pre-configured policy. The policy may include time schedule, threshold limits on ML performance, latency, energy and/or resource usage.

In some embodiments, the first repository function is an analytical data repository function, ADRF, or an analytics training function, NWDAF MTLF, or a model coordination function, or a model repository function.

FIG. 7 illustrates an embodiment 700 of an ML model update at an AnLF with MTLF training performed using a stored ML model. Shown in the embodiment 700 is an NWDAF AnLF 720, an NWDAF MTLF 730, a DCCF/MFAF 740, an NRF 750 and an ADRF 760.

In a first step 701, NWDAF MTLF 730 is pre-configured with re-training policy and/or resource consumption (including energy) target goals to assist in determining under which circumstances it shall use an existing ML Model, or, request to get a stored ML Model from ADRF 760 to use for training.

In a further step 702, NWDAF AnLF 720 decides that it needs ML Model re-training. This process can rely on clause 8.1 of 3GPP TR 23.700-81, for instance. This step is illustrated in step 702 as an ML Model re-training decision.

In a further step 703 NWDAF AnLF 720 issues a ML Model training request towards the associated MTLF 730 indicating any re-training latency goals (max latency) if this is relevant to the Analytics ID (i.e., if analytics involve real-time decisions, e.g., for QoS sustainability).—This is illustrated in step 703 as ‘Nnwdaf_MLModelTraining_Request (training latency, timestamp, data, UE/network object population, performance drift)’.

In further steps 704-705, NWDAF MTLF 730 requests/subscribes to and gets notified from DCCF/MFAF 740 for collecting data (which can alternatively be collected from the data source directly) indicating the desired latency and amount/volume of data that shall be collected. This is illustrated in step 704 as ‘Ndccf_DataManagement_Request/Subscribe (training latency, data amount/statistics)’ and in step 705 as ‘Ndccf_DataManagement_Notify’.

In a further step 706, NWDAF MTLF 730 determines whether the ML Model can be re-trained with new data from the current data sources (in the same geographical area) or the re-training can benefit, i.e., can be faster or more effective, if an existing ML Model stored in ADRF 760 is used. The criteria considered by the MTLF 730 to decide which of the two options may be based on one or more of the following options as elaborated in detail in the disclosure herein: required re-training latency, time schedule (timestamp), performance drift indicated by NWDAF AnLF 720; availability and quantity of data collected from DCCF/MFAF 740 or collected from the data sources directly; NWDAF MTLF 730 resource and/or energy expenditure target goals; NWDAF MTLF 730 post training information, pre-configured policies and/or performance comparison. This is illustrated in step 706 as ‘determining if re-training uses current ML Model or request another stored ML model’.

If the MTLF 730 decides that re-training can benefit from using an existing ML Model then it executes steps 707-710, otherwise it skips them and directly performs the ML Model re-training, i.e., step 711, with new data from the relevant data sources.

In steps 707-708, NWDAF MTLF 730 issues a search request (Nnrf_MLModel_SearchRequest) to the NRF 750 including either a specific ML Model ID if it is known and/or a ML Model Profile or ML Model profile categories.

This is illustrated in step 707 as ‘Nnrf_MLModel_SearchRequest (NF with Model ID, Model profile)’. The NRF 750 responds if there was a match with (Nnrf_MLModel_SearchRequestResponse), providing the NF ID (e.g., ADRF ID) that contains the ML Model ID or ML Model ID set. This is illustrated in step 708 as ‘Nnrf MLModel_SearchRequestResponse’. In case there was no match the process of discovering an existing ML profile is terminated.

In a further step 709, the NWDAF MTLF 730 then requests from the ADRF 760 either directly (Nadrf_MLModel_Requests) or via the DCCF/MFAF 740 the corresponding ML Models using the ML Model ID and ML Model profiles. NWDAF MTLF 730 can request another MTLF in case the desired ML Model is contained there. This is illustrated in step 709 as ‘Nadrf_MLModel_Request/Subscribe (Model ID, Model profile)’.

In a further step 710, the ADRF 760 (or alternatively another MTLF) then responds in step 710 (Nadrf_MLModel_RequestsResponse) with the desired ML Model directly or via the DCCF/MFAF 740. This is illustrated in step 710 as ‘Nadrf_MLModel_Request/Subscribe_Response’.

In step 711, NWDAF MTLF 730 then performs the ML Model re-training (illustrated in step 711 as ‘performs re-training’) using either new data from the existing source or additionally start re-training from an existing stored ML Model retrieved from the ADRF 760 or from another MTLF. Optionally the NWDAF MTLF 730 would request and get a granted permission from the original ML Model creator before it can perform further ML Model updates.

In step 712, NWDAF MTLF 730 then sends the re-trained ML Model to the NWDAF AnLF 720 that issued the re-training request. This is illustrated in step 712 as ‘Nnwdaf_MLModelTraining_RequestResponse’. In case the re-training request was not successful it shall contain the reasons, e.g., no ML Model stored or online data sources could not accommodate specific requirements or conditions. The disclosure herein further provides, an apparatus for wireless communication, comprising a processor and a memory coupled with the processor. The processor configured to cause the apparatus to: receive, from an analytics training function, an ML model update, the ML model update comprising an updated ML model and an associated ML model identifier and/or ML model profile and/or an ML model profile category and/or an ML model information; determine, based on the ML model update, at least one other analytics training function that is subscribed to the apparatus to receive ML model updates for the ML model identifier and/or ML model profile and/or ML model profile category and/or ML model information; and transmit, to the at least one other analytics training function, the ML model update.

In some embodiments, the processor is configured to cause the apparatus to receive, from the at least one other analytics training function, a subscription request, the subscription request comprising the ML model identifier and/or ML model profile and/or ML model profile category and/or ML model information.

In some embodiments the apparatus comprises a data collection coordination function, DCCF/messaging framework adaptor function, MFAF.

In some embodiments the analytics training function is an analytics training function, NWDAF MTLF.

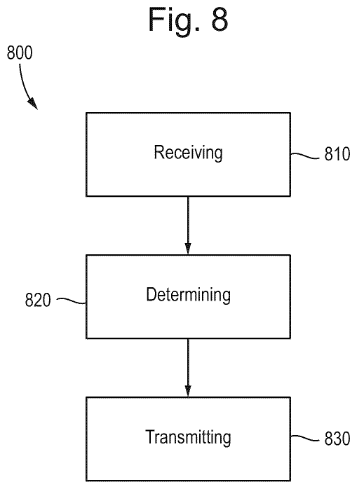

FIG. 8 illustrates an embodiment of a method 800 in an apparatus for wireless communication.

A first step 810 comprises receiving, from an analytics training function, an ML model update, the ML model update comprising an updated ML model, an associated ML model identifier and/or a ML model profile and/or a ML model category and/or a ML model information.

A further step 820 comprises determining, based on the ML model update, at least one other analytics training function subscribed to the apparatus to receive ML model updates for the ML model identifier and/or ML model profile and/or ML model category and/or ML model information.

A further step 830 comprises transmitting, to the at least one other analytics training function, the ML model update.

In certain embodiments, the method 800 may be performed by a processor executing program code, for example, a microcontroller, a microprocessor, a CPU, a GPU, an auxiliary processing unit, a FPGA, or the like.

Some embodiments comprise receiving, from the at least one other analytics training function, a subscription request, the subscription request comprising the ML model identifier and/or ML model profile and/or ML model profile category and/or ML model information.

In some embodiments the apparatus comprises a data collection coordination function, DCCF/messaging framework adaptor function, MFAF.

In some embodiments the analytics training function is an analytics training function, NWDAF MTLF.

More specifically, if the NWDAF MTLF ML Model re-training (in step 711 in FIG. 7) results in a unique new ML Model, it needs to store it to an ADRF. In addition, the NWDAF MTLF may inform a DCCF/MFAF to update other related MTLFs that use prior versions of the same ML Model to proactively perform a ML Model update. FIG. 9 illustrates this process in more detail.

FIG. 9 illustrates an embodiment 900 of a process for an ML model update via DCCF/MFAF towards corresponding MTLFs. The embodiment illustrates NWDAF AnLFs 910, NWDAF MTLFs 920, a specific NWDAF MTLF 930, DCCF/MFAF 940 and ADRF 950.

In a first step 901, NWDAF MTLFs 920 subscribe to receive ML Model updates, to the DCCF/MFAF 940, indicating a ML Model ID and the respective ML Model profile (that contain vendor and version information). This is illustrated in step 901 as ‘Nadrf_MLModel_Request/Subscribe (Model ID, model profile)’.

In a further, optional step 902, the NWDAF MTLF 930 would request and get a granted permission from the original ML Model creator before it can perform further ML Model updates. This is illustrated in step 902 as ‘Nnwdaf MLModel_RetrievalRequest/Response (Model ID, Model Profile)’.

In a further step 903, NWDAF MTLF 930 that received a NWDAF AnLF request (as elaborated in step 703 of FIG. 7) completes the ML Model re-training. This is illustrated in step 903 as ‘performs re-training’. Optionally the NWDAF MTLF 930 would request and get a granted permission from the original ML Model creator before it can perform further ML Model updates.

In a further step 904, NWDAF MTLF 930 provides the updated version of the ML Model to the ADRF 950 and DCCF/MFAF 940 respectively indicating the Model ID and Model profile. This is illustrated in step 904 as ‘Nnwdaf_MLModel_Update (Model ID, Model profile)’.

In a further step 905, once the DCCF/MFAF 940 receives the updated ML Model, it checks the Model ID and model profile to identify other NWDAF MTLFs 920 that may have subscribed to receive ML Model updates. This is illustrated in step 905 as ‘determines other MTLFs that shall receive the updated ML model’.

In a further step 906, DCCF/MFAF 940 then provides the updated ML Model to the corresponding NWDAF MTLFs 920 that subscribed to receive ML Model updates. This is illustrated in step 906 as ‘Ndccf_MLModel_Subscribe_Response (Model ID, Model profile)’.

Further, in steps 906-907, Each NWDAF MTLF 920 once it receives the updated ML Model, optionally processes the necessary re-training if needed (based on its configured policy and AnLF subscriptions). This is illustrated in particular in step 907 as ‘performs re-training’.

In a further step 908, each NWDAF MTLF 902 updates in turn the respective AnLF 910 that subscribed to it.

Proposals are beginning to introduce the capability of storing ML Models i.e., for re-training and inference, in ADRF. However, there is gap on determining: (i) when a stored ML Model shall be used, (ii) what are the respective conditions that can help to assure benefits for adopting and using stored ML Models and (iii) how a newly updated ML Model can be distributed effectively across multiple MTLFs proactively once it becomes available.

This invention relates to an apparatus and method that introduces a mechanism to check when and under which conditions a stored ML Model in a NF or ADRF shall be adopted, therefore exploiting the benefits of re-using a ML Model across different MTLFs with a different area of interest. To accomplish this, this invention exploits the unique ML Model ID and the ML Model profile to be able to select stored ML Models considering: i) the availability schedule and quality of data from current (on-line) data sources, ii) post training information related to model drift, validation and testing, iii) the requested latency of re-training and/or performance drift issued by an AnLF, and iv) pre-configured information related to MTLF resource usage, energy expenditure or other re-training policies. This invention also introduces a mechanism using DCCF/MFAF to assist a proactive ML Model update across multiple MTLFs, by keeping track the MTLFs ML Model ID and model profile.

Current proposals do not consider any mechanism to assist when and examine under which conditions a stored ML Model shall be used. ML Models are only stored in ADRF with their further usage and exploitation being a gap.

The disclosure herein provides for a NWDAF AnLF requesting ML Model re-training from the associated NWDAF MTLF, which decides based on the request attributes if it shall re-train the ML Model using data from the online data sources or switch to another ML Model that shall be retrieved from the ADRF and use this for performing re-training.

The disclosure herein further provides for a NWDAF AnLF requesting ML Model re-training from the associated NWDAF MTLF, which decides based on the preconfigured policy and/or ML Model performance and/or resource management goals if it shall re-train the ML Model using data from the online data sources or switch to another ML Model that shall be retrieved from the ADRF and use this for performing re-training.

The disclosure herein further provides for a NWDAF MTLF that provides ML Model updates to DCCF/MFAF, which proactively distribute the new ML Model version across multiple MTLFs considering their subscription based on the Model ID and Model profile.

In particular, there is provided an apparatus and a method for assisting an analytics training function (for instance an NWDAF MTLF) to determine to use data from online data sources (to train a first ML model) or to select and retrieve a stored ML Model (i.e. a second ML model) from a repository function (e.g., ADRF); to select and retrieve a network function (e.g., MTLF or model coordination function) based on an ML Model ID and/or ML model profile and use the second ML model to replace the existing one (first ML model) for performing training or re-training.

In some embodiments, the decision for using the first- or second-ML Model is determined by a request issued by an analytics inference function (e.g. NWDAF AnLF) that contains one or more of the following parameters or a combination thereof: required latency or speed of re-training; required amount or percentage sample of UEs or network objects; inference information related to ML Model performance drift; indicated timestamp or time schedule for the request for ML Model re-training;

In some embodiments, the decision for using the first- or second-ML Model is determined by the availability of data and/or the data quantity from existing online data sources or stored data. This data may be stored in the first repository function or another repository.

In some embodiments, the availability may rely on the need for real-time data, and/or on the amount or percentage sample of UEs and/or network objects.

In some embodiments, the quantity can be determined based on data statistics semantics (e.g., data volume, range, distribution). Data statistics semantics may comprise data volume, range, distribution, for instance.

In some embodiments, the decision for using the first- or second-ML Model is determined by the analytics training function (e.g. an NWDAF MTLF) based on one or more of the following parameters or a combination thereof: post training information related to the ML model performance that contains model validation and/or testing; data source type and/or the statistics related to the data collected; resource or energy expenditure constraints considering computing resources target goals; latency targets for collecting new data from online data sources and/or computing re-training compared to adopting a stored ML Model and performing re-training; pre-configured policy that may include time schedule, threshold limits on ML performance, latency, energy and/or resource usage. The policy may include time schedule, threshold limits on ML performance, latency, energy and/or resource usage.

There is further provided, an apparatus and a method for enabling an analytics training function (e.g. an NWDAF MTLF) to distribute proactively updated or new ML Models among multiple secondary NWDAF MTLFs by: using a data distribution framework (DCCF/MFAF); allowing secondary NWDAF MTLFs to subscribe for receiving ML Model updates using an ML Model ID and the ML model profile.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer

readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd Generation Partnership Project; 5G, 5th Generation of Mobile Communication; AI/ML, Artificial Intelligence/Machine Learning; ADRF, Analytical Data Repository Function; AF, Application Function; AnLF, Analytics Logical Function; API, Application Protocol Interface; DCCF, Data Collection Coordination Functionality; MF, Management Function; MFAF, Messaging Framework Adaptor Function; MnS, Management Service; MTLF, Model Training Logical Function; NF, Network Function; NRF, Network Repository Function; NWDAF, Network Data Analytics Function; OAM, Operations, Administration and Maintenance; UDM, User Data manager; UDR, User Data Repository; and UE, User Equipment.

1. An apparatus for wireless communication, comprising:
at least one memory; and
at least one processor coupled with the at least one memory and configured to cause the apparatus to:
train a first machine learning (ML) model using data from at least one online data source; or
select and retrieve, from a first repository function, a second ML model, and use the second ML model to replace the first ML model for performing the training.

2. The apparatus of claim 1, wherein the at least one processor is further configured to cause the apparatus to:
receive, from a first network entity, a request for training the first ML model; and
determine whether training for the first ML model is to be performed based on the request for training.

3. The apparatus of claim 2, wherein the request for training comprises one or more parameters from the list of parameters, including:
a required latency, or a speed, of training;
a required amount or percentage sample of user equipment or network entities for providing a required amount of training data;
an inference information related to ML model performance drift; and
a time-schedule or a time-stamp for the request.

4. The apparatus of claim 2, wherein the first network entity is a network data analytics function (NWDAF), an analytics inference function, or an analytics logical function (AnLF).

5. The apparatus of claim 2, wherein the at least one processor is further configured, in determining to select and retrieve from the first repository function the second ML model, to cause the apparatus to:
transmit, to the first repository function, a request for retrieving the second ML model, wherein the request for retrieving comprises an ML model identifier, an ML model profile, an ML model profile category, an ML Model Information; and
receive, from the first repository function, the second ML model, the second ML model being associated with the ML model identifier, the ML model profile, the ML model profile category, or the ML Model Information.

6. The apparatus of claim 5, wherein the at least one processor is further configured to cause the apparatus to:
transmit, to a second repository function, a search request, the search request comprising the ML model identifier, the ML model profile, the ML model profile category, or the ML Model Information; and
receive, from the second repository function, an identifier for the first repository function.

7. The apparatus of claim 6, wherein the second repository function is a network repository function (NRF).

8. The apparatus of claim 5, wherein the at least one processor is configured to cause the apparatus to perform the training using the second ML model, to generate an updated second ML model as a third ML model.

9. The apparatus of claim 2, wherein the at least one processor is configured to cause the apparatus to perform the training using the first ML model and the data from the at least one online data source, in order to generate an updated first ML model as a third ML model.

10. The apparatus of claim 8, wherein the at least one processor is further configured to cause the apparatus to transmit the third ML model to the first network entity that requested the training.

11. The apparatus of claim 8, wherein the at least one processor is further configured to cause the apparatus to transmit the third ML model to at least another network entity that is subscribed to receiving ML model updates.

12. The apparatus of claim 1, wherein the apparatus comprises an analytics training function or a network data analytics function (NWDAF) model training logical function (MTLF).

13. The apparatus of claim 1, wherein the at least one processor is configured to cause the apparatus to determine whether training for the first ML model is to be performed based on:
an availability or quantity of data from the at least one online data source or from stored data.

14. The apparatus of claim 13, wherein the availability of data is determined by a requirement for real-time data or an amount or percentage sample of user equipment or network entities for providing a required amount of training data; and the quantity of data is determined based on data statistics semantics.

15. The apparatus of claim 1, wherein the at least one processor is configured to cause the apparatus to determine whether training for the first ML model is to be performed based on one or more further parameters selected from a list of parameters, including:
a post-training information related to performance of the first or second ML models, wherein the post-training information comprises validation or testing information;
a data source type of the at least one online data source or statistics related to the data collected from the at least one online data source;
a resource or energy expenditure target constraint;
a latency constraint target for collecting data from the at least one online data source, for training the first ML model, or retrieving and using a second ML model for training; and
a pre-configured policy.

16. The apparatus of claim 1, wherein the first repository function is an analytical data repository function (ADRF), a network data analytics function (NWDAF) model training logical function (MTLF). a model coordination function, or a model repository function.

17. An apparatus for wireless communication, comprising:
at least one memory; and
at least one processor coupled with the at least one memory and configured to cause the apparatus to:
receive, from an analytics training function, a machine learning (ML) model update, the ML model update comprising an updated ML model and an associated ML model identifier, ML model profile, ML model profile category, or ML model information;
determine, based on the ML model update, at least one other analytics training function that is subscribed to the apparatus to receive ML model updates for the ML model identifier, the ML model profile, the ML model profile category, or the ML model information; and
transmit, to the at least one other analytics training function, the ML model update.

18. The apparatus of claim 17, wherein the at least one processor is further configured to cause the apparatus to:
receive, from the at least one other analytics training function, a subscription request, the subscription request comprising the ML model identifier, the ML model profile, the ML model profile category, or the ML model information.

19.-20. (canceled)

21. A method in an apparatus for wireless communication, the method comprising:
training a first machine learning (ML) model using data from at least one online data source, or
selecting and retrieving from a first repository function, a second ML model, and using the second ML model to replace the first ML model for performing the training.

22.-30. (canceled)

31. A method in an apparatus for wireless communication, comprising:
receiving, from an analytics training function, a machine learning (ML) model update, the ML model update comprising an updated ML model, an associated ML model identifier, a ML model profile, a ML model category, or a ML model information;
determining, based on the ML model update, at least one other analytics training function subscribed to the apparatus to receive ML model updates for the ML model identifier, the ML model profile, the ML model category, or the ML model information; and
transmitting, to the at least one other analytics training function, the ML model update.
